(19) United States
(12) Patent Application Publication
(10) Pub. No.: US 2005/0202376 A1
(43) Pub. Date: Sep. 15, 2005

(54) Emotional sensor, a communication call

(76) Inventor: Arturo Olaya, Corona, NY (US)

Correspondence Address: Arturo Olaya;Apt L3, 39-06 114 Street, Corona, NY, 11368, US

(21) Appl. No.: 10/775,969

(22) Filed: Feb. 11, 2004

(51) Int. Cl. G09B 19/00

(52) U.S. Cl. 434/98; 434/128; 434/168; 434/170; 434/176

(57) ABSTRACT

A method, system and tool for allowing abstract communication based on the psychological characteristics of colors. Promoting the emission of messages related to individual's emotional states and giving clear signals that opening doors to verbal communication and welcoming people to surroundings of understanding. Exposing first, the board of magnetic material which illustrates the elements to accomplish non verbal communication and to encourage deeper levels of verbal interaction, a set of multicolored cones which represent the members of the group and some of their psychological factors, a supply of colored indicators that placed on the correspondent cone will create either a message facilitated from the color's significance or simply an attempt to get attention from others. The Sensor will provide features to accurate the message not only giving promptness, with the S.O.S. bar but also offering room for short written messages with the writing board and an erasable marker. The emotional sensor will encourage people to show his or her feelings at the exact moment they would like to express them and the appearance of the board will be the visual testimony of the group's commitment with communication.

### CROSS-REFERENCE TO RELATED APPLICATIONS

Application No.: 60/444,736

Feb. 5, 2003

License for foreign filing license granted.

### STATEMENT REGARDING FEDERALLY SPONSORED RESEARCH

“Not Applicable”

### REFERENCE TO SEQUENCE LISTING, A TABLE, OR COMPUTER PROGRAM LISTING COMPACT DISC APPENDIX

“Not Applicable”

### BACKGROUND OF THE INVENTION

Life is now complex and hectic, people are informed about events around the world; however, there is not enough time to talk among people sharing a space.

Colors are radiant energy that have been used to communicate for a long time such as traffic lights and signals, but more than cultural symbols, colors have characteristics that have been studied for many years (Babitt, E. The Principles of Light, and Color, 1878) determining that color enters our body and stimulates glands, producing hormones, affecting processes, that is why every color is associated with certain physical and psychological factors. (Birre, F. Color Psychology and Colortherapy, 1961). It has been established that colors have direct influence on thoughts, moods and behavior and numerous studies show the close relationship between, light color and self power (Weiss, M. Healing through colors, 1993).

Experts are aware of the increase of several mental problems i.e. depression, anxiety, food related traumas, many of which are diagnosed as malfunctions of exogenous origin, directly related with loneliness, feelings of abandonment or a sense of being misunderstood.

There are quite a lot of devices and techniques being developed for people to be in touch meant for promptness and for impersonalized massive communication.

Magnetic boards and magnetically attractable materials are used for decorative and educational purposes, but none of them are yet used to facilitate dialogue in small groups, the lightness, easy reception of colors and the stability of the elements once placed on the board has encouraged the use of this material in this invention.

This invention cannot be called a game or an educative kit, it is a tool that simplifies complex concepts from different sciences such as Psychology, Sociology and Chromo therapy as an instrument of easy and simple use where small groups interact; in order to achieve communication.

### BRIEF SUMMARY OF THE INVENTION

The present invention is a tool that allows communication using the combination of colors to give a non verbal message and announce an invitation to talk about ourselves. With a board that represent different members of a group and colors providing the subject and quality of a message, a complete form of communication is established. But the final object is to make those two persons involved (addresser and receptor) jump from the initial non verbal “colored message” to a verbal communication where the initial message becomes explicit and detailed.

The sensor was specifically made to “brake the ice” and encourage people to let others know how they feel and to generate environments where is easier to express. The inspiration and final goal of the emotional sensor is to contribute with an implement to transform a difficult task: Start a conversation about how we feel, making this an easy and often situation, therefore help to solve conflicts and make people feel that there are others out there to listen and to be listened.

Any feeling, idea, announcement and fact can be suggested in the sensor. Coding is given to guide people in the process of getting familiar with the employ of colors to express.

### BRIEF DESCRIPTION OF THE SEVERAL VIEWS OF THE DRAWING

FIG. 1 Is a front view of the board called sensor showing all the components involved, to achieve the purpose of the present invention, is the way the sensor looks when it has not been manipulated.

FIG. 2 Is a front view of the multicolor cones that represent each member of the group.

FIG. 3 Is a front view of one cone identified with the name of one of the members of the group.

FIG. 4 Is a front view of one cone identified with a picture of one of the members of the group.

FIG. 5 Is a front view of the colored pieces called indicators.

FIG. 6 Is a front view of the S.O.S. Bar which is affixed under the cones.

FIG. 7 Is a front view of the S.O.S. Bar whit an indicator placed on it.

FIG. 8 Is a front view of the Writing board exposed in the board.

FIG. 9 Is a front view of an example of a message written on the Writing board

FIG. 10 Is a front view of the chart that provides significance of colors chart.

FIG. 11 Is a front view of an example of a yellow indicator placed on a green section of a sensor.

FIG. 12 Is a front view of the manual that will be annexed to guide the use of colors for expressing.

### DETAILED DESCRIPTION OF THE INVENTION

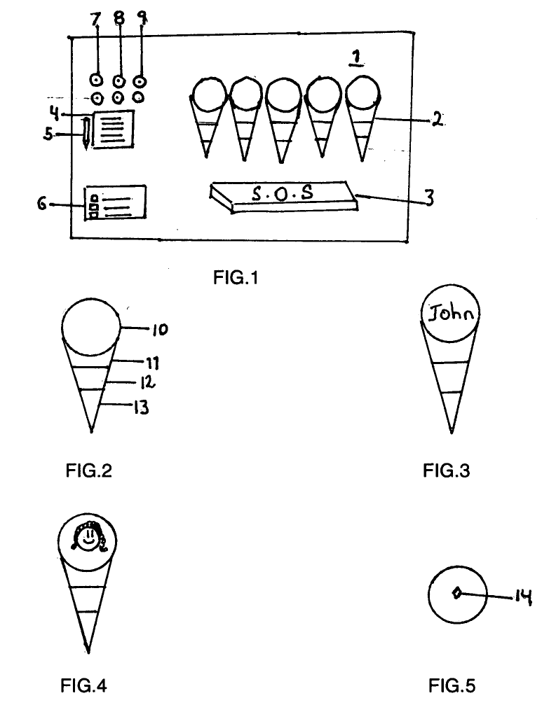

FIG. 1 is the front page view, shows how the present invention looks, after being displayed on the refrigerator or any other visible permanent point that has easy access. Manufactured in a sheet of magnetic material of 8.5 by 11 inches, of 1/16 inches of thickness, the board is impressed in a sheet of shiny adhesive paper as fallows: The background is light blue 1 and on it are also impressed five multicolor inverted cones 2 which are called sensors, the S.O.S. Bar 3, the writing board 4 and a erasable marker 5 the chart of the significance of the colors 6, providing reference for three colors (green, yellow and red). There will be a small clear plastic bag with six indicators of three different colors, that should be displayed on the superior left corner as seen, two are green 7, two are yellow 8 and there are two red 9, they are removable objects in order to be affixed to different parts of the board by magnetic attraction. All this should be a permanent display in a place where a family, a work team, or a group of friends interact.

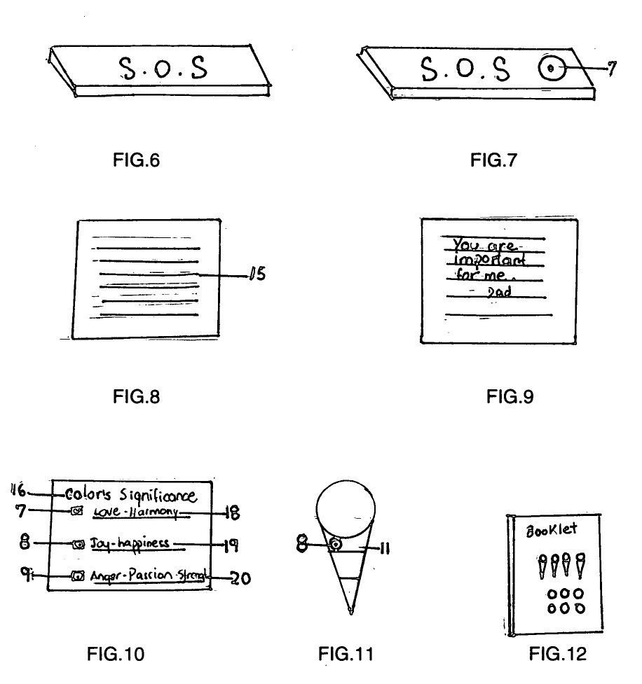

In FIG. 2 the illustration of a inverted cone is shown, they are called sensors and give the name to the concept, since the inventor considers them as the nucleus and most important part, they represent every member of the group, there are five in total, estimating this as the maximum number of persons involved in the dynamic. The cones are 3 inches long, their top which is a blue circle 10 has a diameter of 2.0 cm, where the name of the person is exposed in FIG. 5 can be written or like in FIG. 6 a small picture can be glued, the inventor encourages the use of pictures as a more coherent procedure with the concept and for the power that a visual image of certain person can have. Every color was chosen for its long studied psychological characteristics, the base is blue, for its association with harmony, since is the part that surrounds the name or the picture of the person. The body of the cones are divided in three parts of three different colors, symbolizing the way we humans are multicolored with emotions and feelings that can be defined with determined color. From the top to the bottom, the first part 11 is green is identified like “The house of spirituality”, represents the part of every human being that relates to self realization, hope and integrity. The second part 12 is yellow is named “The house of happiness” employed when somebody wants to express enthusiasm, eagerness, zest or excitement. And the bottom part is red 13 called “The house of Passion” stands for the psychological processes as pain, anger, strength, passion and sensuality we all experience.

FIG. 5 is a drawing of a circular shape with 1.0 cm of diameter, is made in fiber glass, holds a small shiny piece 14 emulating a diamond to make the indicator eye-catching; its base is covered by magnetic material that permits adhesion to the board. Its function in the invention is to add the intensity and quality of the feeling or emotional situation a person is experiencing. An indicator can be of three colors Green 7 to express the sense of well being, balance and peace in a particular physical or psychological component, Yellow 8 to add abundance, joy or excitement to a certain area of somebody's life a and Red 9. to show passion, danger in a singular aspect. Therefore a green indicator placed on the green part of the sensor will give us the message that something has to be spoken related to a sense of being in peace in the area of spirituality.

Turning to FIG. 6 a front view of the S.O.S. bar is a red tri dimensional rectangular figure of 2.5 by 0.5 inches, with the white letters S.O.S. on it, the inventor has selected this code because this bar is on the board exactly with the purpose to be a call for help after several attempts to establish communication have been done. The person will make a S.O.S call by picking a colored indicator and setting it on the bar. The color of the indicator will give the area of the life of the person in which he or she is feeling extreme discomfort. In FIG. 7 an example of an indicator 7 placed on the S.O.S. bar can be seen, in this way the sender of the message will let others know he needs to solve a conflict or talk about an issue right away, that it can not wait any longer to get a reaction.

In FIG. 8 Is a front view of the writing board with 2.o by 2.o inches, is colored rectangle area in orange and white, and has 11 lines 15 where any short idea or message will be written, can be any kind of sentence. Provides room to anybody's initiative to precise whatever was expressed with colors. In FIG. 9 an example of a message is shown.

In FIG. 10 We have the Color's significance 16 that is a quick guide of the psychological characteristics of colors, in that way a person can look at this chart if is not familiar with the meanings of colors yet, after reading the manual, which is shown in FIG. 12, This area 17 situated in the inferior left corner of the board shows illustrations of a green indicator 7 and its meanings 18, of a yellow indicator 8, and its connotations 19 and a red indicator 9 with three adjectives 20.

Finally in FIG. 11 is a front view of the a sensor with a yellow indicator 8 on its green part 11. Expressing happiness (yellow indicator) and showing changes in self realization (green section of the sensor).

In FIG. 12 there is a front view of the manual's cover, a booklet, that briefly will introduce people to the world of colors and expressing with them on the sensor.

It can now be seen the process of how a board, described in detail previously, with some colored pieces attached can be a tool for people to communicate as fallows: A small group of people should read the manual FIG. 12 get to know the colors and their characteristics. Place the sensor on its refrigerator thanks to the magnetic material. Identify the cones either with words FIG. 3 or pictures FIG. 4 and get ready to communicate with color FIG. 11 and express, if is necessary, on the writing board FIG. 9, or if is the case, using the help bar FIG. 6 and FIG. 7. Every time the person is not sure about how to say it with colors can check the color's significance chart FIG. 10. Then he or she will take an indicator FIG. 5 and make the communication call placing this on a chosen colored area of the own sensor, based on his or her emotional state and psychological needs, and will wait to establish a dialogue.

1. A system for promoting abstract communication between members of small groups based on the psychological characteristics of colors. Presented as a colorful board made of retractable magnetic material and illustrations for specific use, together with pieces to adhere to it, that with the intervention of an agent will complete the process of communication.

2. A method as defined in claim 1 that will allow the emission of messages with inverted cones colored in green, yellow and red which are attributed to each member of the group of persons and the addition of indicative agents also green, yellow and red, producing a communication call of psycho affective connotation with characteristics determined by their combination.

3. A didactic tool as described in claim 2 that will introduce a new way of communicating with colors within families, work teams, sport teams or any type of small group with common goal and awareness of the emotional stats of their members in order to achieve personal growth and stronger bonds.
